(19) United States
(12) Patent Application Publication
(10) Pub. No.: US 2023/0220242 A1
(43) Pub. Date: Jul. 13, 2023

(54) POLY(METH)ACRYLATE-BASED PRESSURE-SENSITIVE ADHESIVES COMPRISING AT LEAST ONE ACRYLONITRILE-BUTADIENE RUBBER

(71) Applicant: tesa SE, Norderstedt (DE)

(72) Inventors: Anika PETERSEN, Heidmuehlen (DE); Hans-Peter GRAEF, Hamburg (DE); Ann-Kathrin NAEGELE, Hamburg (DE)

(73) Assignee: tesa SE, Norderstedt (DE)

(21) Appl. No.: 18/095,886

(22) Filed: Jan. 11, 2023

(30) Foreign Application Priority Data
Jan. 11, 2022 (DE) 10 2022 100 562.3

(51) Int. Cl. C09J 7/10; C09J 7/38

(52) U.S. Cl. CPC C09J 7/10; C09J 7/385; C09J 2433/00; C09J 2415/00; C09J 2301/408

(57) ABSTRACT

The present invention relates to a pressure-sensitive adhesive comprising
at least one poly(meth)acrylate; and
at least one acrylonitrile-butadiene rubber, wherein
   the at least one acrylonitrile-butadiene rubber is present at 1 to 49 wt %, based on the total weight of the pressure-sensitive adhesive. The invention further relates to the production of a pressure-sensitive adhesive of the invention and also to the use of the pressure-sensitive adhesive of the invention for the bonding of components of electronic devices or of components in automobiles. Lastly the present invention relates to an adhesive tape comprising at least one layer of a pressure-sensitive adhesive according to the present invention.

This application claims priority of German Patent Application No. 10 2022 100 562.3, filed Jan. 11, 2022, the entire contents of which are hereby incorporated herein by reference.

The present invention relates to a pressure-sensitive adhesive comprising
at least one poly(meth)acrylate; and
at least one acrylonitrile-butadiene rubber, wherein

the at least one acrylonitrile-butadiene rubber is present at 1 to 49 wt %, based on the total weight of the pressure-sensitive adhesive. The invention further relates to the production of a pressure-sensitive adhesive of the invention and also to the use of the pressure-sensitive adhesive of the invention for the bonding of components of electronic devices or of components in automobiles. Lastly the present invention relates to an adhesive tape comprising at least one layer of a pressure-sensitive adhesive according to the present invention.

Pressure-sensitive adhesives (PSAs) are known in the prior art. For example DE 102013215297 A1 describes PSAs based on poly(meth)acrylates with at least one synthetic rubber and at least one tackifier compatible with the one or more poly(meth)acrylate(s). PSAs of this kind, however, have a poor chemical resistance, with respect to oleic acid for example.

PSAs which have chemical resistance are described for example in WO 2017/025492 A1. However, they are based on acrylonitrile-butadiene rubber. Such adhesives, however, have a low cohesion.

It was an object of the present invention, therefore, to provide poly(meth)acrylate-based pressure-sensitive adhesives which exhibit not only high chemical resistance, especially toward oleic acid, but also high shear strength.

The object has surprisingly been achieved by the pressure-sensitive adhesives of the present invention, more particularly by the combination of a poly(meth)acrylate-based compound with 1 to 49 wt % of at least one acrylonitrile-butadiene rubber.

A first and general subject of the invention is a pressure-sensitive adhesive comprising
at least one poly(meth)acrylate; and
at least one acrylonitrile-butadiene rubber, wherein
   the at least one acrylonitrile-butadiene rubber is present at 1 to 49 wt %, preferably 10 to 45 wt %, more preferably 20 to 45 wt %, based on the total weight of the pressure-sensitive adhesive.

A second aspect of the present invention is a process for producing a pressure-sensitive adhesive according to the present invention, where the producing comprises passage through a compounding and extrusion apparatus and the process is a continuous process.

In a third aspect, the present invention relates to the use of a pressure-sensitive adhesive according to the present invention for bonding components of electronic devices or of components in automobiles.

In a fourth aspect, the present invention relates to an adhesive tape comprising at least one layer of a pressure-sensitive adhesive according to the present invention.

### BRIEF DESCRIPTION OF THE DRAWING

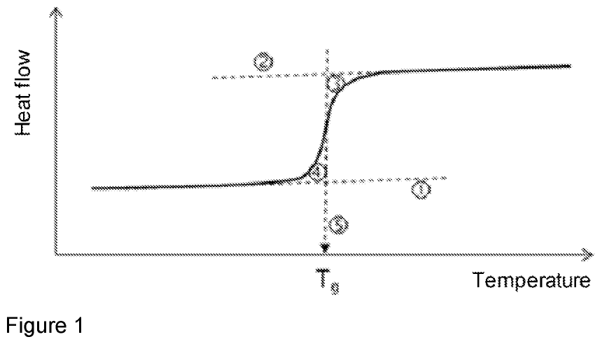

The present invention will be described in greater detail with reference to the drawing, wherein FIG. 1 is a graph that will be used below to illustrate how a glass transition temperature measurement is made.

What is understood by a pressure-sensitive adhesive or PSA in accordance with the invention, as usual in general parlance, is a substance which, at least at room temperature, is permanently tacky and adhesive. The characteristic feature of a pressure-sensitive adhesive is that it can be applied to a substrate by pressure and remains stuck thereon, without specific definition of the pressure to be expended and the duration of action of this pressure. In general, but fundamentally depending on the exact nature of the pressure-sensitive adhesive, the temperature and air humidity, and the substrate, the action of a brief minimal pressure not extending beyond gentle contact for a brief moment is sufficient to achieve the bonding effect; in other cases, a longer duration of action at a higher pressure may also be necessary.

Pressure-sensitive adhesives have particular, characteristic viscoelastic properties that lead to sustained tackiness and adhesiveness. It is characteristic of these that, if they are mechanically deformed, there are both viscous flow processes and buildup of elastic resilience forces. The two processes are in a particular ratio to one another with regard to their respective proportion, depending both on the exact composition, the structure and the level of crosslinking of the pressure-sensitive adhesive and on the speed and duration of the deformation, and also on the temperature.

The viscous flow component is needed for achievement of adhesion. Only the viscous components, frequently caused by macromolecules having relatively high mobility, enable good wetting and good flow to the substrate to be bonded. A high proportion of viscous flow leads to high pressure-sensitive tack (also referred to as tack or surface tack) and hence often also to a high adhesion. Highly crosslinked systems, crystalline polymers or polymers that have solidified in vitreous form, for lack of free-flowing components, are generally not tacky or at least only slightly tacky.

The elastic resilience force components are needed for achievement of cohesion. These forces are caused, for example, by very long-chain and highly entangled macromolecules, and by physically or chemically crosslinked macromolecules, and enable transfer of the forces that attack an adhesive bond. They have the effect that an adhesive bond can withstand a sustained stress that acts thereon, for example in the form of a sustained shear stress, to a sufficient degree over a prolonged period of time.

For more exact description and quantification of the degree of the elastic and viscous components, and of the ratio of the components to one another, the parameters of storage modulus (G′) and loss modulus (G″) that are determinable by means of dynamic-mechanical analysis (DMA) are cited. G′ is a measure of the elastic component, G″ a measure of the viscous component of a substance. The two parameters are dependent on the deformation frequency and the temperature.

The parameters can be ascertained with the aid of a rheometer. The material to be examined is subjected here, for example in a plate-plate arrangement, to a sinusoidally oscillating shear stress. In shear stress-controlled instruments, deformation as a function of time, and the offset in this deformation over time with respect to the introduction of shear stress are measured. This offset over time is referred to as phase angle δ.

Storage modulus G′ is defined as follows: G′=(τ/γ)·cos(δ) (τ=shear stress, γ=deformation, δ=phase angle=phase shift between shear stress vector and deformation vector). The definition of loss modulus G″ is: G″=(τ/γ)·sin(δ) (τ=shear stress, γ=deformation, δ=phase angle=phase shift between shear stress vector and deformation vector).

An adhesive is considered to be a pressure-sensitive adhesive especially and is defined as such in the invention especially when, at 23° C., in the deformation frequency range from 10⁰ to 10¹ rad/sec, both G′ and G″ are at least partly within the range from 10³ to 10⁷ Pa. What is meant by “partly” is that at least a section of the G′ curve is within the window defined by the deformation frequency range from 10⁰ to 10¹ rad/sec inclusive (abscissa) and the range of G′ values from 10³ to 10⁷ Pa inclusive (ordinate), and at least a section of the G″ curve is likewise within the corresponding window.

A “poly(meth)acrylate” is understood to mean a polymer obtainable by radical polymerization of acrylic monomers and/or methacryl monomers and optionally further copolymerizable monomers. More particularly, a “poly(meth)acrylate” is understood to mean a polymer having a monomer basis consisting to an extent of at least 50 wt % of acrylic acid, methacrylic acid, acrylic esters and/or methacrylic esters, where acrylic esters and/or methacrylic esters are present at least in part, preferably to an extent of at least 30 wt %, based on the overall monomer basis of the polymer in question.

The pressure-sensitive adhesive of the invention preferably comprises poly(meth)acrylate at 40 wt %, more preferably at 45 to 99 wt %, more particularly at 48 to 70 wt %, based in each case on the total weight of the pressure-sensitive adhesive. It is possible for a (single) poly(meth)acrylate or multiple poly(meth)acrylates to be present, and where there are multiple poly(meth)acrylates present, the expression “the pressure-sensitive adhesive comprises poly(meth)acrylate at . . . wt %” of course means “the pressure-sensitive adhesive comprises poly(meth)acrylate at in total . . . wt %”.

The glass transition temperature of the poly(meth)acrylate in the pressure-sensitive adhesive of the invention is preferably <0° C., more preferably between −5 and −50° C. The glass transition temperature of polymers or of polymer blocks in block copolymers is determined in accordance with the invention by means of dynamic scanning calorimetry (DSC). For this purpose, about 5 mg of an untreated polymer sample is weighed into an aluminum boat (volume 25 μl) and closed with a perforated lid. The measurement is made using a DSC 204 F1 from Netzsch. A nitrogen atmosphere is employed for inertization. The sample is first cooled down to −150° C., then heated up to +150° C. at a heating rate of 10 K/min and cooled down again to −150° C. The subsequent second heating curve is run again at 10 K/min and the change in heat capacity is recorded. Glass transitions are recognized as steps in the thermogram.

The glass transition temperature is obtained as follows (see FIG. 1): The respectively linear region of the measurement curve before and after the step is extended in the direction of rising temperatures (area before the step) or falling temperatures (area after the step) (tangents \textcircled{1} and \textcircled{2}). In the region of the step, a line of best fit \textcircled{5} is run parallel to the ordinate such that it intersects with both tangents, specifically in such a way as to form two equal areas \textcircled{3} and \textcircled{4} (between the respective tangent, the line of best fit and the measurement curve). The point of intersection of the line of best fit thus positioned with the measurement curve gives the glass transition temperature.

The poly(meth)acrylate in the pressure-sensitive adhesive of the invention preferably comprises at least one proportionally copolymerized functional monomer which is more preferably reactive with epoxy groups to form a covalent bond. Most preferably, the proportionally copolymerized functional monomer which is more preferably reactive with epoxy groups to form a covalent bond contains at least one functional group selected from the group consisting of carboxylic acid groups, sulfonic acid groups, phosphonic acid groups, hydroxy groups, acid anhydride groups, epoxy groups and amino groups; it especially contains at least one carboxylic acid group. Extremely preferably, the poly(meth)acrylate in the pressure-sensitive adhesive of the invention contains proportionally copolymerized acrylic acid and/or methacrylic acid. All the groups mentioned have reactivity with epoxy groups, which means that the poly(meth)acrylate is advantageously amenable to thermal crosslinking with introduced epoxides.

The poly(meth)acrylate in the pressure-sensitive adhesive of the invention may preferably be based on the following monomer composition:
a) at least one acrylic ester and/or methacrylic ester of the following formula (1)

CH₂=C(R^{I})(COOR^{II}) (1)
in which R^{I}=H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxy groups, acid anhydride groups, epoxy groups and amino groups;

c) optionally further acrylic esters and/or methacrylic esters and/or olefinically unsaturated monomers copolymerizable with component (a).

It is particularly advantageous to choose the monomers of component a) with a proportion of 45 to 99 wt %, the monomers of component b) with a proportion of 1 to 15 wt % and the monomers of component c) with a proportion of 0 to 40 wt %, where the figures are based on the monomer mixture for the base polymer without additions of any additives such as resins etc.

The monomers of component a) are generally plasticizing, comparatively nonpolar monomers. More preferably, in the monomers a) is an alkyl radical having 4 to 10 carbon atoms or 2-propylheptyl acrylate or 2-propylheptyl methacrylate. The monomers of the formula (1) are especially selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate and 2-propylheptyl methacrylate.

The monomers of component b) are more preferably selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

Illustrative monomers of component c) are:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methyl-undecyl)-acrylamide, N-(n-butoxymethyl)acrylamide, N-(butoxymeth-yl)methacrylamide, N-(ethoxymethyl)acrylamide, N-(n-octadecyl)acrylamide; N,N-dialkyl-substituted amides, for example N,N-dimethylacrylamide and N,N-dimethylmethacrylamide, N-benzylacrylamide, N-isopropylacrylamide, N-tert-butylacrylamide, N-tert-octylacrylamide, N-methylolacrylamide, N-methylolmethacrylamide, acrylonitrile, methacrylonitrile; vinyl ethers such as vinyl methyl ether, ethyl vinyl ether, vinyl isobutyl ether; vinyl esters such as vinyl acetate; vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-di-methoxystyrene; macromonomers such as 2-polystyreneethyl methacrylate (weight-average molecular weight Mw, determined by GPC, of 4000 to 13 000 g/mol), poly(methyl methacrylate)ethyl methacrylate (Mw of 2000 to 8000 g/mol).

Monomers of component c) may advantageously also be chosen such that they contain functional groups that assist subsequent radiochemical crosslinking (for example by electron beams, UV). Suitable copolymerizable photoinitiators are, for example, benzoin acrylate and acrylate-functionalized benzophenone derivatives. Monomers that assist crosslinking by electron bombardment are, for example, tetrahydrofurfuryl acrylate, N-tert-butylacrylamide and allyl acrylate.

The preparation of the poly(meth)acrylates is preferably accomplished by conventional radical polymerizations or controlled radical polymerizations. The poly(meth)acrylates can be prepared by copolymerization of the monomers using customary polymerization initiators and optionally chain transfer agents, by polymerization at the customary temperatures in bulk, in emulsion, for example in water or liquid hydrocarbons, or in solution.

The poly(meth)acrylates are preferably prepared by copolymerizing the monomers in solvents, more preferably in solvents having a boiling range of 50 to 150° C., especially of 60 to 120° C., using 0.01 to 5 wt %, especially 0.1 to 2 wt %, based in each case on the total weight of the monomers, of polymerization initiators.

All customary initiators are suitable in principle. Examples of radical sources are peroxides, hydroperoxides and azo compounds, for example dibenzoyl peroxide, cumene hydroperoxide, cyclohexanone peroxide, di-t-butyl peroxide, cyclohexylsulfonylacetyl peroxide, diisopropyl percarbonate, t-butyl peroctoate and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the preparation of the poly(meth)acrylates are alcohols such as methanol, ethanol, n- and isopropanol, n- and isobutanol, especially isopropanol and/or isobutanol; hydrocarbons such as toluene and especially benzines with a boiling range from 60 to 120° C.; ketones, especially acetone, methyl ethyl ketone, methyl isobutyl ketone, esters such as ethyl acetate, and mixtures of the aforementioned solvents. Particularly preferred solvents are mixtures containing isopropanol in amounts of 2 to 15 wt %, especially of 3 to 10 wt %, based in each case on the solvent mixture used.

The production (polymerization) of the poly(meth)acrylates is preferably followed by a concentration step, and the further processing of the poly(meth)acrylates is essentially solvent-free. The concentration of the polymer can be accomplished in the absence of crosslinker and accelerator substances. But it is also possible to add one of these compound classes to the polymer even before the concentration, such that the concentration is then performed in the presence of this/these substance(s).

After the concentration step, the polymers can be transferred to a compounder. The concentration and compounding may optionally also take place in the same reactor.

The weight-average molecular weights M_{w} of the polyacrylates are preferably within a range from 20 000 to 2 000 000 g/mol; very preferably within a range from 100 000 to 1 500 000 g/mol, exceptionally preferably within a range from 150 000 to 1 000 000 g/mol. For this purpose, it may be advantageous to conduct the polymerization in the presence of suitable polymerization chain transfer agents such as thiols, halogen compounds and/or alcohols in order to establish the desired average molecular weight.

The number-average molar mass Mₙ and weight-average molar mass M_{w} figures in this document relate to determination by gel permeation chromatography (GPC), which is known per se. The determination is made on a 100 μl clear-filtered sample (sample concentration 4 g/1). The eluent used is tetrahydrofuran with 0.1% by volume of trifluoroacetic acid. The measurement is made at 25° C.

The pre-column used is a column of the PSS-SDV type, 5 μm, 10³ Å, 8.0 mm*50 mm (figures here and hereinafter in the sequence: type, particle size, porosity, internal diameter*length; 1 Å=10⁻¹⁰ m). Separation is accomplished using a combination of columns of the PSS-SDV type, 5 μm, 10³ Å, and 10⁵ Å and 10⁶ Å, each with 8.0 mm*300 mm (columns from Polymer Standards Service; detection by means of Shodex R171 differential refractometer). The flow rate is 1.0 ml per minute. Calibration in the case of poly(meth)acrylates is against PMMA standards (polymethylmethacrylate calibration) and otherwise (resins, elastomers) against PS standards (polystyrene calibration).

The poly(meth)acrylates preferably have a K value of 30 to 90, more preferably of 40 to 70, measured in toluene (1% solution, 21° C.). Fikentschers K value is a measure of the molecular weight and viscosity of polymers.

The principle of the method is based on the determination of the relative solution viscosity by capillary viscometry. For this purpose, the test substance is dissolved in toluene by shaking for 30 minutes, so as to obtain a 1% solution. In a Vogel-Ossag viscometer, at 25° C., the flow time is measured and this is used to determine the relative viscosity of the sample solution with respect to the viscosity of the pure solvent. According to Fikentscher [P. E. Hinkamp, Polymer, 1967, 8, 381], it is possible to read off the K value from tables (K=1000 k).

The poly(meth)acrylate in the pressure-sensitive adhesive of the invention preferably has a polydispersity PD<4 and hence a relatively narrow molecular weight distribution. Adhesives based thereon, in spite of a relatively low molecular weight, after crosslinking have particularly good shear strength. Moreover, the relatively low polydispersity enables easier processing from the melt since the flow viscosity is lower compared to a poly(meth)acrylate of broader distribution with largely the same application properties. Poly(meth)acrylates having a narrow distribution can advantageously be prepared by anionic polymerization or by controlled radical polymerization methods, the latter being of particular good suitability. It is also possible to prepare corresponding poly(meth)acrylates via N-oxyls. In addition, it is advantageously possible to use atom transfer radical polymerization (ATRP) for synthesis of narrow-distribution poly(meth)acrylates, preferably using monofunctional or difunctional, secondary or tertiary halides as initiator, and complexes of Cu, Ni, Fe, Pd, Pt, Ru, Os, Rh, Co, Ir, Ag or Au for abstraction of the halides. RAFT polymerization is also suitable.

The poly(meth)acrylates in the pressure-sensitive adhesive of the invention are preferably crosslinked by linkage reactions—especially in the form of addition or substitution reactions—of functional groups present therein with thermal crosslinkers. It is possible to use any thermal crosslinkers which
both assure a sufficiently long processing time, such that there is no gelation during the processing operation, especially the extrusion operation,
and also lead to rapid post-crosslinking of the polymer to the desired level of crosslinking at lower temperatures than the processing temperature, especially at room temperature.

One possible example are polymers containing a combination of carboxy, amino and/or hydroxy groups, and as crosslinkers isocyanates, especially aliphatic or blocked isocyanates, examples being trimerized isocyanates deactivated with amines. Suitable isocyanates are, in particular, trimerized derivatives of MDI [4,4-methylenedi(phenyl isocyanate)], HDI [hexamethylene diisocyanate, hexylene 1,6-diisocyanate] and IPDI [isophorone diisocyanate, 5-isocyanato isocyanatomethyl-1,3,3-trimethylcyclohexane], examples being the products Desmodur® N3600 and XP2410 (each from Bayer AG: aliphatic polyisocyanates, low-viscosity HDI trimers). Likewise suitable is the surface-deactivated dispersion of micronized, trimerized IPDI BUEJ 339®, now HF9® (Bayer AG).

Preference is given to using thermal crosslinkers at 0.1 to 5 wt %, especially at 0.2 to 1 wt %, based on the total amount of the polymer to be crosslinked.

Crosslinking via complexing agents, also referred to as chelates, is also possible. An example of a preferred complexing agent is aluminum acetylacetonate.

The poly(meth)acrylates in the pressure-sensitive adhesive of the invention are preferably crosslinked by means of one or more epoxides or by means of one or more substances containing epoxy groups. The substances containing epoxy groups are more particularly polyfunctional epoxides, i.e., those with at least two epoxy groups; the overall result is accordingly indirect linkage of the units of the poly(meth)acrylates that bear the functional groups. The substances containing epoxy groups may be either aromatic or aliphatic compounds.

Outstandingly suitable polyfunctional epoxides are oligomers of epichlorohydrin, epoxy ethers of polyhydric alcohols, especially of ethylene glycol, propylene glycol and butylene glycol, polyglycols, thiodiglycols, glycerol, pentaerythritol, sorbitol, polyvinyl alcohol, polyallyl alcohol and the like; epoxy ethers of polyhydric phenols, especially of resorcinol, hydroquinone, bis(4-hydroxyphenyl)-methane, bis(4-hydroxy-3-methylphenyl)methane, bis(4-hydroxy-3,5-dibromophenyl)-methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphen-yl)phenylmethane, bis(4-hydroxyphenyl)-phenylmethane, bis(4-hydroxy-phenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxy-phenyl)-cyclohexylmethane, 4,4′-dihydroxydiphenyl, 2,2′-dihydroxydiphenyl, 4,4′-dihydroxydiphenyl sulfone and the hydroxyethyl ethers thereof; phenol-formaldehyde condensation products such as phenol alcohols and phenol-aldehyde resins; S- and N-containing epoxides, for example N,N-diglycidylaniline and N,N′-dimethyldiglycidyl-4,4-diaminodiphenylmethane, and epoxides that have been prepared by customary methods from polyunsaturated carboxylic acids or monounsaturated carboxylic esters of unsaturated alcohols; glycidyl esters, and polyglycidyl esters, which can be obtained by polymerization or copolymerization of glycidyl esters of unsaturated acids or from other acidic compounds, for example from cyanuric acid, diglycidyl sulfide or cyclic trimethylene trisulfone or derivatives thereof.

Examples of very suitable ethers are butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether and bisphenol F diglycidyl ether.

Other preferred epoxides are cycloaliphatic epoxides such as 3,4-epoxycyclohexylm ethyl 3,4-epoxycyclohexanecarboxylate (UVACure1500).

More preferably, the poly(meth)acrylates are crosslinked by means of a crosslinker-accelerator system (“crosslinking system”), in order to obtain better control over the processing time, crosslinking kinetics and degree of crosslinking.

The crosslinker-accelerator system preferably comprises at least one substance containing epoxy groups as crosslinker, and at least one substance having accelerating action at a temperature below the melting temperature of the polymer to be crosslinked for crosslinking reactions by means of compounds containing epoxy groups as accelerator.

Accelerators used in accordance with the invention are more preferably amines. These should be regarded in a formal sense as substitution products of ammonia; in the formulas that follow, the substituents are represented by “R” and especially include alkyl and/or aryl radicals. Particular preference is given to using those amines that enter into only a low level of reactions, if any, with the polymers to be crosslinked.

In principle, accelerators chosen may be primary (NRH₂), secondary (NR₂H) or else tertiary amines (NR₃), and of course also those having multiple primary and/or secondary and/or tertiary amino groups. Particularly preferred accelerators are tertiary amines, for example triethylamine, triethylenediamine, benzyldimethylamine, dimethylaminomethylphenol, 2,4,6-tris(N,N-dimethylaminomethyl)phenol and N,N′-bis(3-(dimethylamino)propyl)urea. Further preferred accelerators are polyfunctional amines such as diamines, triamines and/or tetramines, for example diethylenetriamine, triethylenetetramine and trimethylhexamethylenediamine.

Further preferred accelerators are amino alcohols, especially secondary and/or tertiary amino alcohols, where, in the case of multiple amino functionalities per molecule, preferably at least one amino functionality is and more preferably all amino functionalities are secondary and/or tertiary. Particularly preferred accelerators of this kind are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butyl-ethanolamine, 2-[bis(2-hydroxyethyl)amino]-2-(hydroxymethyl)propane-1,3-diol, 1-[bis(2-hydroxyethyl)amino]-2-propanol, triisopropanolamine, 2-(dimeth-ylamino)ethanol, 2-(diethylamino)ethanol, 2-(2-dimethylaminoethoxy)ethanol, N,N, N′-trimethyl-N′-hydroxyethyl bisaminoethyl ether, N,N,N′-tri-methylaminoethylethanolamine and N,N,N′-trimethylaminopropylethanolamine.

Further suitable accelerators are pyridine, imidazoles, for example 2-methylimidazole, and 1,8-diazabicyclo[5.4.0]undec-7-ene. It is also possible to use cycloaliphatic polyamines as accelerator. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerators; examples are tetrabutylammonium hydroxide, cetyltrimethylammonium bromide and benzalkonium chloride.

In the PSA of the invention, the acrylonitrile-butadiene rubber is present preferably in dispersion in the poly(meth)acrylate. Poly(meth)acrylate and acrylonitrile-butadiene rubber, accordingly, are preferably each homogeneous phases. The poly(meth)acrylates and acrylonitrile-butadiene rubbers present in the PSA are preferably chosen such that at 23° C. they are not miscible with one another to the point of homogeneity. At least microscopically and at least at room temperature, therefore, the PSA of the invention preferably has at least two-phase morphology. More preferably, poly(meth)acrylate(s) and acrylonitrile-butadiene rubber(s) are not homogeneously miscible with one another in a temperature range from 0° C. to 50° C., more particularly from −30° C. to 80° C., and so in these temperature ranges the PSA at least microscopically is in at least two-phase form.

Components are defined for the purposes of this specification as “not homogeneously miscible with one another” when even after intermediate mixing, the formation of at least two stable phases is detectable physically and/or chemically, at least microscopically, with one phase being rich in one component and the second phase being rich in the other component. Presence of negligibly small amounts of one component in the other, without opposing development of the multiphase character, is considered insignificant in this regard. Hence the poly(meth)acrylate phase may contain small amounts of acrylonitrile-butadiene rubber, and/or the acrylonitrile-butadiene rubber phase may contain small amounts of poly(meth)acrylate component, as long as these amounts are not substantial amounts which influence the phase separation.

The phase separation may be realized in particular such that discrete regions (“domains”) which are rich in acrylonitrile-butadiene rubber—in other words are essentially formed of acrylonitrile-butadiene rubber—are present in a continuous matrix which is rich in poly(meth)acrylate—in other words is essentially formed of poly(meth)acrylate. One suitable system of analysis for a phase separation is, for example, scanning electron microscopy. Alternatively, phase separation may also be detectable, for example, by the different phases having two glass transition temperatures independent of one another in dynamic scanning calorimetry (DSC) or dynamic-mechanical analysis (DMA). Phase separation is present according to the invention when it can clearly be shown by at least one of the analytical methods.

The PSA of the present invention comprises at least one acrylonitrile-butadiene rubber at 1 to 49 wt %, preferably up to 10 to 45 wt %, more preferably 20 to 40 wt %, based on the total weight of the PSA. When there are two or more acrylonitrile-butadiene rubbers present, “the PSA comprises at least one acrylonitrile-butadiene rubber at . . . wt %” means of course that “the PSA comprises acrylonitrile-butadiene rubber at in total . . . wt %”.

Acrylonitrile-butadiene rubbers, abbreviated code NBR, derived from “nitrile butadiene rubber”, denote a synthetic rubber obtained by copolymerizing acrylonitrile and buta-1,3-diene in proportions by mass of approximately 52:48 to 10:90. NBR production is almost exclusively in aqueous emulsion. The resultant emulsions are used as such (NBR latex) or worked up to be solid rubber.

In the polymerization context, a distinction is made in principle between cold and hot polymerization, so-called. The cold polymerization takes place customarily at temperatures from 5 to 15° C. and in contrast to hot polymerization, which is carried out usually at 30 to 40° C., results in a lower number of chain branches.

NBR rubbers are available commercially from a host of manufacturers such as, for example, Nitriflex, Zeon, LG Chemicals, and Lanxess. Suitable NBRs are available commercially, for example, under the tradename Nipol, especially Nipol DN401 L, Nipol N917, and Nipol 1001CG, and Zetpol, more particularly Zetpol 2001, Zetpol 2001EP, Zetpol 4310 and Zetpol 4310EP, from Zeon.

Carboxylated NBR grades are formed by terpolymerization of acrylonitrile and butadiene with small fractions of (meth)acrylic acid in emulsion. The selective hydrogenation of the C,C double bond in NBR leads to hydrogenated nitrile rubbers (H-NBRs). Vulcanization takes place using customary sulfur crosslinkers, peroxides, or by means of high-energy radiation. Suitable carboxylated NBR grades are available, for example, commercially from Arlanxeo under the tradenames Krynac X160 and Krynac X750.

In one preferred embodiment, the at least one acrylonitrile-butadiene rubber is a hydrogenated or a part-hydrogenated acrylonitrile-butadiene rubber.

In another preferred embodiment, the at least one acrylonitrile-butadiene rubber is carboxylated.

In another embodiment, the at least one acrylonitrile-butadiene rubber is a carboxylated and hydrogenated or part-hydrogenated acrylonitrile-butadiene rubber.

Besides carboxylated or hydrogenated NBR rubbers there are also liquid NBR rubbers. These are limited in molecular weight during the polymerization by the addition of polymerization chain transfer agents, and are therefore obtained as liquid rubbers.

PSAs of the invention may comprise not only one or more solid acrylonitrile-butadiene rubbers but also at least one liquid acrylonitrile-butadiene rubber.

The fraction of the liquid acrylonitrile-butadiene rubbers is preferably up to 20 wt %, more preferably between 1 and 15 wt %, more preferably between 2 and 10 wt %, based on the total weight of the acrylonitrile-butadiene rubbers.

A factor distinguishing liquid rubbers relative to solid rubbers is that they have a softening point of <40° C. The figures for the softening point TE of oligomeric and polymeric compounds, such as of the resins, for example, relate to the ring & ball method as per DIN EN 1427:2007 with appropriate application of the determinations (investigation of the oligomer or polymer sample instead of bitumen, with the procedure otherwise retained); the measurements are made in a glycerol bath.

In one preferred embodiment the at least one acrylonitrile-butadiene rubber has an acrylonitrile fraction of 10 to 60 wt %, preferably 15 to 50 wt %, based on the total weight of the acrylonitrile-butadiene rubber.

In one preferred embodiment the at least one acrylonitrile-butadiene rubber has a Mooney viscosity of at least 19, preferably 20 to 100, at 100° C., measured according to DIN 53523-2:1991-05.

A PSA of the invention preferably comprises at least one tackifier, which may also be termed a peel adhesion booster or tackifying resin, which is compatible in particular with the poly(meth)acrylate and/or acrylonitrile-butadiene rubber. A “tackifier” in accordance with the general understanding of the skilled person is an oligomeric or polymeric resin which increases the adhesion (the peel adhesion) of the PSA in comparison to the otherwise identical PSA containing no tackifier.

A “tackifier compatible with the poly(meth)acrylate” is a tackifier which alters the glass transition temperature of the system obtained after thorough mixing of poly(meth)acrylate and tackifier as compared with the pure poly(meth)acrylate, with only one Tg being assignable to the mixture of poly(meth)acrylate and tackifier too. A tackifier not compatible with the poly(meth)acrylate would lead to two Tgs in the system obtained after thorough mixing of poly(meth)acrylate and tackifier, where one of which would be assignable to the poly(meth)acrylate and the other to the resin domains. The determination of the Tg in this context takes place calorimetrically by means of DSC (differential scanning calorimetry).

The tackifier compatible with the poly(meth)acrylate preferably has a DACP of less than −30° C., more preferably of at most −70° C., most preferably of less than −50° C. and/or preferably a MMAP of less than 40° C., more preferably of at most 30° C., more particularly 24 to 28° C. For determining the DACP and MMAP values, reference is made to C. Donker, PSTC Annual Technical Seminar, Proceedings, pp. 149-164, May 2001.

With particular preference the tackifier compatible with the poly(meth)acrylate is selected from the group consisting of (meth)acrylate resins, rosin derivatives, and hydrocarbon resins containing aromatics, more preferably aromatic-rich hydrocarbon resins; more particularly, from the group consisting of (meth)acrylate resins and aromatic hydrocarbon resins. Especially preferably the tackifier compatible with the poly(meth)acrylate is a (meth)acrylate resin. This makes it possible in particular to improve the adhesion on polar bond substrates. A PSA of the invention may also comprise mixtures of two or more tackifiers. Among the rosin derivatives, preference is given to rosin esters.

A PSA of the invention preferably comprises tackifiers compatible with the poly(meth)acrylate at in total of 5 to 25 wt %, more preferably at in total 8 to 18 wt %, based in each case on the total weight of the PSA.

The pressure-sensitive adhesive of the invention preferably comprises

40-98 wt % of the at least one poly(meth)acrylate,

1-49 wt % of the at least one acrylonitrile-butadiene rubber, and

1-30 wt % of the at least one tackifier,

based in each case on the total weight of the PSA. More preferably the sum total of the wt % of the at least one poly(meth)acrylate and of the at least one tackifier is at least 55 wt %, more particularly at least 60 wt %, based in each case on the total weight of the PSA.

More particularly the pressure-sensitive adhesive of the invention comprises

48-70 wt % of the at least one poly(meth)acrylate,

20-40 wt %, of the at least one acrylonitrile-butadiene rubber, and

5 to 25 wt % of the at least one tackifier,

based in each case on the total weight of the PSA.

Depending on the field of use and desired properties of the PSA of the invention, it may comprise further components and/or additives, in each case on its/their own or in combination with one or more other additives or components. Preferred embodiments are described below.

The PSA of the invention may further comprise at least one polyurethane- and/or silicone-based filler. In general all polyurethane- and silicone-based fillers that are known in the field are suitable, but the PSA preferably comprises at least one polyurethane- and/or silicone-based filler in the form of solid polymer beads, more particularly those having a diameter of 4 to 30 μm.

Solid polymer beads of this kind may be used in the form, for example, of an about 50% masterbatch in a dispersion medium such as EVA during the production of the PSA.

Alternatively or additionally the PSA of the invention may comprise, for example, fillers, in powder and granular form, including more particularly abrasive and reinforcing fillers, which are different from the polyurethane- and/or silicone-based filler; dyes; and pigments such as, for example, chalks (CaCO₃), titanium dioxide, zinc oxides and/or carbon blacks.

Suitable additives for the PSA of the invention are additionally—chosen independently of other additives—nonexpandible hollow polymer beads or solid polymer beads, hollow glass beads, solid glass beads, hollow ceramic beads, solid ceramic beads and/or solid carbon beads (“carbon microballoons”).

Accordingly to one preferred embodiment, the PSA of the invention is foamed. The foaming is accomplished preferably by the introduction and subsequent expansion of microballoons. In one preferred embodiment the PSA of the invention comprises at least one tackifier and/or a multiplicity of microballoons.

“Microballoons” are hollow microbeads which are elastic and therefore expandible in their ground state, which have a thermoplastic polymer shell. These beads are filled with low-boiling liquids or liquefied gas. Shell materials used include, in particular, polyacrylonitrile, PVDC, PVC or polyacrylates. A suitable low-boiling liquid is, in particular, hydrocarbons of the lower alkanes, as for example isobutane or isopentane, which are enclosed as a liquified gas under pressure in the polymer shell.

The outer polymer shell is caused to soften by exposure of the microballoons, more particularly by thermal exposure. At the same time the liquid blowing gas present within the shell undergoes a transition to its gaseous state. In this process, the microballoons expand irreversibly and three-dimensionally. Expansion is at an end when the internal pressure matches the external pressure. Since the polymeric shell is retained, the product is a closed-cell foam.

A multiplicity of types of microballoon are available commercially, differing essentially in their size (6 to 45 μm diameter in the unexpanded state) and in their start temperatures required for expansion (75 to 220° C.). One example of commercially available microballoons are the Expancel® DU grades (DU=dry unexpanded) from Akzo Nobel.

Unexpanded microballoon grades are also available in the form of an aqueous dispersion having a solids content or microballoon content of around 40 to 45 wt %, and also in the form of polymer-bound microballoons (masterbatches), as for example in ethyl-vinyl acetate with a microballoon concentration of around 65 wt %. Not only the microballoon dispersions but also the masterbatches, like the DU grades, are suitable for producing a foamed PSA of the invention.

A foamed PSA of the invention may also be generated using what are called preexpanded microballoons. In the case of this group, the expansion takes place even before incorporation into the polymer matrix. Preexpanded microballoons are available commercially, for example, under the Dualite® designation or with the type designation “Expancel xxx DE” (DE=dry expanded) from Akzo Nobel.

Preferably in the invention at least 90% of all the cavities formed by microballoons have a maximum diameter of 10 to 200 μm, more preferably of 15 to 200 μm. The “maximum diameter” refers to the maximum extent of a microballoon in any direction in space.

The diameters are determined on the basis of a cryofracture edge in a scanning electron microscope (SEM) at 500-times magnification. The diameter of each individual microballoon is ascertained graphically.

Where foaming takes place using microballoons, the microballoons may be supplied to the formation in the form of a batch, a paste or an unextended or extended powder. They may also be present in suspension in solvent.

The fraction of the microballoons in the adhesive according to one preferred embodiment of the invention is between greater than 0 wt % and 10 wt %, more particularly between 0.25 wt % and 5 wt %, more especially between 0.5 and 1.5 wt %, based in each case on the overall composition of the adhesive.

The absolute density of a foamed PSA of the invention is preferably 350 to 1200 kg/m³, more preferably 600 to 1000 kg/m³, more particularly 750 to 950 kg/m³. The relative density describes the ratio of the density of the foamed PSA of the invention to the density of the unfoamed PSA of the invention with identical formation. The relative density of a PSA of the invention is preferably 0.35 to 0.99, more preferably 0.45 to 0.97, more particularly 0.50 to 0.90.

The PSA of the invention may further comprise low-flammability fillers, for example ammonium polyphosphate; electrically conductive fillers, for example conductive carbon black, carbon fibers and/or silver-coated beads; thermally conductive materials, for example boron nitride, aluminum oxide, silicon carbide; ferromagnetic additives, for example iron(III) oxides; organic renewable raw materials, for example wood flour; organic and/or inorganic nanoparticles; fibers, compounding agents, aging inhibitors, light stabilizers and/or antiozonants.

The PSA of the invention optionally comprises one or more plasticizers. Examples of plasticizers which can be added include (meth)acrylate oligomers, phthalates, hydrocarbon oils, cyclohexanedicarboxylic esters, water-soluble plasticizers, plasticizing resins, phosphates or polyphosphates.

The PSA of the invention preferably comprises silicas, more preferably precipitated silica, more particularly precipitated silica surface-modified with dimethyldichlorosilane. With this additive it is possible advantageously to establish the thermal shear strength of the PSA.

The thickness of a PSA of the invention in web form is preferably 50 to 1500 μm, more preferably 70 to 1200 μm, more particularly 100 to 800 μm, for example 150 μm to 500 μm or 200 μm to 400 μm.

The PSA of the present invention may take the form of a pressure-sensitive adhesive film. This may be accomplished by customary coating methods known to the skilled person. In that case the PSA, including the additives, in solution in a suitable solvent, may be coated by means, for example, of halftone roll application, comma bar coating, multiroll coating, or in a printing process, onto a carrier film or release film, after which the solvent can be removed in a drying tunnel or drying oven. Alternatively the carrier film or release film may also be coated in a solvent-free process. For that purpose the acrylonitrile-butadiene rubber and the poly(meth)acrylate are heated in an extruder and melted. Further operating steps may take place in the extruder such as mixing with the described additives, filtration, or degassing. The melt is then coated onto the carrier film or release film by means of a calendar.

A further subject of the invention is the use of a PSA of the invention for bonding components of electronic devices, particularly displays, or components in or on automobiles, more particularly for the bonding of electronic components in automobiles and for the bonding of trim strips or emblems on clearcoat finishes of automobiles. Particularly in the context of the bonding of high-value individual parts of electronic devices, such as displays, for example, the possibility of repositioning the components, already outlined above, is particularly advantageous. Bonds using PSAs of the invention may be made either manually or with automation.

A further subject of the present invention, finally, is an adhesive tape comprising at least one layer of a pressure-sensitive adhesive according to the present invention.

### EXAMPLES

Characterization of NBr

| | | Mooney |
|---|---|---|
| | ACN content | Viscosity ML at |
| | (%) | 100° C. (MU) |
| Nipol ® DN401L | 17-20 | 60-70 |
| Nipol ® N917 | 21-24 | 55-70 |
| Nipol ® 1001CG | 39-42 | 70-95 |

General experimental description: Production of the pressure-sensitive adhesives

Production of Polyacrylate 1:

A reactor conventional for radical polymerizations was charged with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through the reactor for 45 minutes, with stirring, the reactor was heated to 58° C. and 50 g of AIBN in solution in 500 g of acetone were added. The external heating bath was then heated to 75° C. and the reaction was carried out constantly at this external temperature. After 1 h a further 50 g of AIBN in solution in 500 g of acetone were added, and after 4 h the reaction mixture was diluted with 10 kg of acetone/isopropanol mixture (94:6).

After 5 h and again after 7 h, the reaction was reinitiated with in each case 150 g of bis(4-tert-butylcyclohexyl) peroxydicarbonate in each case in solution in 500 g of acetone. After a reaction time of 22 h, the polymerization was canceled and the system was cooled to room temperature. The product had a solids content of 55.8% and was dried.

Production of Polyacrylate 2:

A 300 l reactor conventional for radical polymerizations was charged with 47 kg of n-butyl acrylate, 20 kg of methyl acrylate, 30 kg of 2-phenoxyethyl acrylate, 3 kg of acrylic acid and 72.4 kg of benzine/acetone (70:30). After nitrogen gas had been passed through the reactor for 45 minutes, with stirring, the reactor was heated to 58° C. and 50 g of Vazo® 67 (2,2′-azobis(2-methylbutyronitrile)) were added. The jacket temperature was then heated to 75° C. and the reaction was carried out constantly at this external temperature. After a reaction time of 1 h, 10 g of Vazo® 67 were added. After 3 h, dilution took place with 20 kg of benzine/acetone (70:30), and after 6 h with 10 kg of benzine/acetone (70:30). For reduction of the residual initiators, 0.15 kg of Perkadox® 16 (di(4-tert-butylcyclohexyl) peroxydicarbonate) was added after each of 5.5 h and 7 h. After a reaction time of 24 h, the reaction was disconnected and the system was cooled to room temperature. The solution was adjusted to a solids content of 38 wt %.

### Production Process, Comparative Example 1

The pressure-sensitive adhesive was homogenized as solvent-based compounds in a kneading apparatus with double-sigma kneading hook. The solvent used was butanone (methyl ethyl ketone, 2-butanone). The kneading apparatus was cooled by means of water cooling. In a first step, the solid acrylonitrile-butadiene rubber was first preswollen with the same amount of butanone at 23° C. for 12 hours. This prebatch, as it is known, was then kneaded for 2 hours. Subsequently, again, the above-selected amount of butanone and optionally the liquid NBR rubber were added in two steps, with kneading for 10 min in each case. The tackifying resin was added subsequently as a solution in butanone with a solids content of 50%, followed by homogenous kneading for 20 min more. The final solids content is adjusted to 30 wt % by addition of butanone.

### Production Process, Comparative Example 2

The SIS Quintac® 3421 in pellet form was melted in a planetary roller extruder via a solids metering system. Added subsequently were the polyacrylate premelted and concentrated in a single-screw extruder, the acrylate resin Paraloid® DM55, the microballoons (Expancel® 920DU40). A crosslinker (Uvacure® 1500) as well was added to the mixture. The melt was mixed and shaped via a double-roll calendar between two release films (siliconized PET film) into a layer having a thickness of 200 μm.

General Production Process, Examples Conforming to the Invention:

The acrylonitrile rubber Nipol® DN401L in pellet form was melted in a planetary roller extruder via a solids metering system. Added subsequently were the polyacrylate premelted and concentrated in a single-screw extruder, the acrylate resin Paraloid® DM55, and/or the aromatic resin Picco® AR100, the microballoons (Expancel® 920DU40). A crosslinker (Uvacure® 1500) as well was added to the mixture. The melt was mixed and shaped via a double-roll calendar between two release films (siliconized PET film) into a layer having a thickness of 200 μm.

The composition of the resultant layers of adhesive was as follows:

Comparative example 1: 70 wt % of Nipol® N917, 30 wt % Picco® AR 100

Comparative example 2: 50.7 wt % polyacrylate 1, 33 wt % Quintac® 3421, 13.0 wt % Paraloid® DM55, 0.3 wt % crosslinker, 1.0% Expancel® 920DU40 microballoons.

Inventive example 1: 50.2 wt % polyacrylate 1, 34.75 wt % Nipol® DN401 L, 14.0 wt % Picco® AR100, 0.3 wt % crosslinker, 0.75 wt % Expancel® 920DU40 microballoons.

Inventive example 2: 50.2 wt % polyacrylate 1, 34.75 wt % Nipol® DN401 L, 14.0 wt % Paraloid® DM55, 0.3 wt % crosslinker, 0.75 wt % Expancel® 920DU40 microballoons.

Inventive example 3: 59.2 wt % polyacrylate 1, 28.5 wt % Nipol® DN401L, 11.25 wt % Picco® AR100, 0.3 wt % crosslinker, 0.75 wt % Expancel® 920DU40 microballoons.

Inventive example 4: 49 wt % polyacrylate 1, 28.95 wt % Nipol® DN401L, 13.0 wt % Picco® AR100, 8.0 wt % Paraloid® DM55, 0.3 wt % crosslinker, 0.75 wt % Expancel® 920DU40 microballoons.

Inventive example 5: 50.2 wt % polyacrylate 2, 34.75 wt % Nipol® DN401L, 14.0 wt % Paraloid® DM55, 0.3 wt % crosslinker, 0.75 wt % Expancel® 920DU40 microballoons.

Inventive example 6: 67.95 wt % polyacrylate 1, 22.0 wt % Nipol® DN917, 9.0 wt % Picco® AR100, 0.3 wt % crosslinker, 0.75 wt % Expancel® 920DU40 microballoons.

Test Methods

Test 1: Activation=Instantaneous Peel Adhesion on Plastic

The determination of the peel adhesion on plastic took place under test conditions of 23° C.+/−1° C. temperature and 50%+/−5% relative humidity, the plastic substrate used being a plate of 30% glass fiber-reinforced PBT with a surface roughness of 1 μm.

For the purpose of cleaning and conditioning prior to measurement, the test plate was first wiped down with ethanol and then left to stand in the air for 5 minutes to allow the solvent to evaporate. The side of the single-layer adhesive tape facing away from the test substrate was then lined with 36 μm etched PET film, to prevent the specimen stretching during the measurement. The test specimen was then rolled down onto the plastic substrate. For this purpose the tape was rolled down back and forth twice using a 2 kg rubber roller at a rolling velocity of 10 m/min. Immediately after it had been rolled down, the adhesive tape was peeled off from the plastic substrate at an angle of 180°, and the force required to achieve this measured with a Zwick tensile testing machine. The measurement results are reported in N/cm and are averaged from three individual measurements.

Drop Tower Test Method (Penetration Resistance)

A square sample in the shape of a frame was cut from the adhesive tape under investigation (area 180 mm²; border width 2.0 mm).

Control Measurement:

The sample was adhered to a steel frame which had been cleaned with acetone. On the other side of the adhesive tape a steel window cleaned with acetone was stuck. The bonding of steel frame, adhesive tape frame and steel window took place in such a way that the geometric centers and the diagonals were each superimposed on one another (corner to corner). The bond was subjected to pressure at 62 N for 10 s and was stored for 72 hours with conditioning at 23° C./50% relative humidity. The sample was subsequently stored at 65° C. for a further 72 h. After removal of the sample from storage, the test specimens were conditioned at 23° C./50% r.H for 2 h.

Measurement after Immersion in Oleic Acid:

The sample is prepared as for the control measurement. Following the conditioning at 23° C./50% r.H. for 72 h, the sample is positioned such that it is lying on the steel window. As a result of the steel frame already bonded, there is now a cavity present, into which 0.7 ml of oleic acid is introduced. The samples are then stored in a sealed container at 65° C. for 72 h. After the 72 h, the samples are cleaned by drawing up the oleic acid with cotton and conditioning the samples again at 23° C./50% r.H. for 2 h.

For the implementation of the measurement, the test specimen is inserted in the sample holder of the instrumented drop apparatus in such a way that the assembly was horizontal, with the steel window facing downward. The measurement took place by instrument and automatically, using a loading weight of 5 kg and a drop height of 20 cm. The kinetic energy introduced by the loading weight destroyed the adhesive bond, by fracture of the adhesive tape between window and frame, and the force was recorded every μs by a piezoelectric sensor. The associated software accordingly gave the graph for the force/time progression after the measurement, and from this it was possible to determine the maximum force Fmax. Shortly before the impact of the rectangular impact geometry on the window, the velocity of the falling weight was determined using two light beams. On the assumption that the energy introduced is large relative to the impact resistance of the adhesive bond, the force progression, the time taken for detachment, and the velocity of the falling weight were used to ascertain the work performed by the bond before complete detachment, i.e., the detachment work. Five test specimens of each sample were investigated; the final impact resistance result consists of the average of the detachment work (Energy in J) or the maximum force (Fmax in N) for these five samples.

Static shear test at 70° C.

An adhesive transfer tape with dimensions of 13×20 mm was bonded without air bubbles to a steel plate which had been cleaned with acetone.

The reverse face of the adhesive tape was lined with aluminum foil. The bond was rolled down a total of 4 times using a 2 kg steel roller at a velocity of 10 m/min. The test specimen was suspended on a shear test measuring station which is combined with a heating cabinet. Loading took place with 5 N. The test was considered to be at an end when the bond has failed or the specified test time has expired. The result is reported in min and is the median of 3 individual measurements.

TABLE 1
properties of the inventive examples and comparative examples

| | | | Penetration | |
|---|---|---|---|---|
| | | | resistance after | |
| | | Penetration | oleic acid | |
| | | resistance | immersion | |
| | Activation | control | (Energy | Static shear |
| | PBT 1 μm | (Energy | J/Fmax N) | test at 70° C. |
| | (N/cm) | J/Fmax N) | Chemical | (min) |
| Property | Adhesion | Impact | resistance | Cohesion |
| Comparative | 1.61 | 1.28/1558 | 0.28/870 | 599 |
| example 1 | | | | |
| Comparative | 0.52 | 1.03/1729 | 0.061/788 | >10 000 |
| example 2 | | | | |
| Inventive | 3.4 | 1.11/1275 | 0.181/737 | >10 000 |
| example 1 | | | | |
| Inventive | 1.06 | 0.99/1612 | 0.195/754 | >10 000 |
| example 2 | | | | |
| Inventive | 3.96 | 1.09/1553 | 0.170/634 | >10 000 |
| example 3 | | | | |
| Inventive | 3.56 | 1.01/1644 | 0.207/786 | >10 000 |
| example 4 | | | | |
| Inventive | 3.43 | 0.98/1394 | 0.129/744 | >10 000 |
| example 5 | | | | |
| Inventive | 6.14 | 1.09/1658 | 0.136/836 | >10 000 |
| example 6 | | | | |

Examples according to the invention exhibit not only good resistance toward chemicals (oleic acid as example) but also a high shear strength.

Comparative example 1, a pure NBR tape, exhibits inadequate shear strength.

Comparative example 2, blend of Ac polymer and SIS, exhibits inadequate chemical resistance.

What is claimed is:

1. A pressure-sensitive adhesive comprising
at least one poly(meth)acrylate; and
at least one acrylonitrile-butadiene rubber, wherein
the at least one acrylonitrile-butadiene rubber is present at 1 to 49 wt %, based on a total weight of the pressure-sensitive adhesive.

2. The pressure-sensitive adhesive as claimed in claim 1, wherein the at least one acrylonitrile-butadiene rubber has an acrylonitrile fraction of 10 to 60 wt %, based on a total weight of the acrylonitrile-butadiene rubber.

3. The pressure-sensitive adhesive as claimed in claim 1, wherein the at least one acrylonitrile-butadiene rubber is a hydrogenated or part-hydrogenated acrylonitrile-butadiene rubber.

4. The pressure-sensitive adhesive claim 1, wherein the at least one acrylonitrile-butadiene rubber has a Mooney viscosity of at least 19 at 100° C., measured according to DIN ISO 289-1:2018-12.

5. The pressure-sensitive adhesive claim 1, wherein the pressure-sensitive adhesive is a pressure-sensitive adhesive in web form.

6. The pressure-sensitive adhesive claim 1, wherein the pressure-sensitive adhesive contains 40 wt % of poly(meth)acrylate, based on the total weight of the pressure-sensitive adhesive.

7. The pressure-sensitive adhesive claim 1, wherein the pressure-sensitive adhesive is a foamed pressure-sensitive adhesive.

8. The pressure-sensitive adhesive claim 1, wherein the pressure-sensitive adhesive comprises at least one tackifier and/or a multiplicity of microballoons.

9. A process for producing a pressure-sensitive adhesive as claimed in claim 1, where comprising passing components of the pressure-sensitive adhesive through a compounding and extrusion apparatus and the process is a continuous process.

10. A method comprising bonding components of an electronic device or components in an automobile with a pressure-sensitive adhesive as claimed in claim 1.

11. An adhesive tape comprising at least one layer of a pressure-sensitive adhesive as claimed in claim 1.
